(19) United States
(12) Patent Application Publication
(10) Pub. No.: US 2010/0143219 A1
(43) Pub. Date: Jun. 10, 2010

(54) PROCESS FOR THE PRODUCTION OF NANO LEAD OXIDES

(75) Inventor: Siew Hon Chow, Selangor (MY)

Correspondence Address: WOLF GREENFIELD & SACKS, P.C., 600 ATLANTIC AVENUE, BOSTON, MA, 02210-2206, US

(73) Assignee: TAI-KWONG-YOKOHAMA BATTERY INDUSTRIED SDN BHD, SEMENYIH (MY)

(21) Appl. No.: 12/448,713

(22) PCT Filed: Jan. 3, 2008
(86) PCT No.: PCT/MY2008/000001

§ 371 Date: Feb. 9, 2010

(30) Foreign Application Priority Data
Jan. 5, 2007 (MY) PI 20070012

(51) Int. Cl. C22B 13/08; C01G 21/02

(52) U.S. Cl. 423/92; 423/89; 977/773

(57) ABSTRACT

Provided is a process for producing fine particles of pure lead oxide from a waste lead oxide paste obtained from exhausted lead-acid batteries. The lead oxide particles so produced are substantially spherical and have a weight average particle size from about 13 nm to about 100 nm, which, are of nano-particle dimensions. The process according to the present invention is capable to produce pure lead oxide of PbO2 and lead oxide of Pb3O4 or commonly known as red lead.

### TECHNICAL FIELD

The invention relates to a process for the recovery and production of lead oxides in pure state from lead bearing materials, especially from exhausted lead-acid batteries. More particularly, the present invention is capable to produce lead oxide powders of nano fine particle size and narrow size distribution.

### BACKGROUND ART

With increased industrialization, the usage of lead is ever on the rise. Exhausted industrial products containing lead bearing materials pose as a major source of pollution problems to our environment. For the past few decades, efforts have been doubled to investigate into new methods to recover lead constituents from exhausted industrial products e.g. lead-acid batteries with the aim to lower the negative impact of used lead on our environment and hence reduce the associated pollution problems.

Generally, exhausted batteries still consist of chemically reactive lead compounds in additional to other battery parts such as metal grids and plastics. In recent years, the recovery and re-use of lead materials contained in lead-acid batteries, majority of which are used as electric starting batteries in motor vehicles have attracted huge industrial interest from developed as well as developing countries. This situation is easily understood given the fact that each motor vehicle alone accounts for about 5 Kg of spent lead material annually. As the number of motor vehicles escalates every year in almost every country in the world, the stocks of scrapped batteries continue to grow and really constitute a huge concern and potential hazard to the environment.

Both in the countries where motor vehicles are manufactured and in the countries where motor vehicles are imported, the total availability of lead materials in exhausted batteries can be extremely sizable and should easily run into hundreds of thousand metric tons per year. To complicate matters further, many of the motor vehicles user countries belong to the developing or least developing world where there is hardly any policy or control measure to manage and look after environmental pollution issues.

Therefore, the lead recovery process from exhausted lead-acid batteries becomes a real since it covers a substantial portion of the availability of lead in the market, which otherwise would be thrown into the wide resulting in very complex environmental problems. In this regard, the pyrometallurgical recovery methods are of actual commercial interest to industrial operators. As it is known, however the pyrometallurgical processes require substantially sophisticated installations and are complicated to operate. Moreover, such methods also pose potential health problems to their workers and have negative repercussion on the immediate surroundings.

In general, the pyrometallurgical recovery methods require installation of reduction furnaces, which would inevitably result in the formation of hydrogen during the charging process thereof especially at the vicinity of the recovery plants. The hydrogen thus released from metallurgical processes would react chemically with the antimony and arsenic present in traditional storage batteries as alloying elements to yield volatile arsine and stibine, both of which are very harmful industrial by-products.

In fact, it is realistic to anticipate that the above-mentioned pyrometallurgical recovery plants will eventually be banned from operation in the many involved countries in view of their negative effects on the ecology thereof due to the formation of volatile compounds. Therefore, there is a pressing need to work for better methods to recover lead materials from scrapped lead-acid storage batteries, which do not involve the emission of volatile compounds and other harmful industrial by-products.

Therefore, future lead recovery methods should be rid of the above setbacks and capable to produce less harmful slurries that may harm the rivers and water in the surrounding vicinities. From the commercial standpoint, such lead recovery methods should also be less capital intensive to install and require less labor to operate them.

There are also a number of other prior arts concerning lead recovery methods in the US patents, wherein respective technical difficulties are mentioned. For instance, in U.S. Pat. No. 1,148,062 the lead oxides produced are not of high quality. According to U.S. Pat. No. 4,222,769, lead pastes extracted from scrapped batteries are de-sulfurized and then transformed into metallic lead by roasting in the presence of a carbon reducing agent. By the latter patent, the cost incurred is not only high but also the final lead product is in the form of metallic lead, which most of the time requires to be further converted to the oxides according to the respective market requirements.

Accordingly, it is a primary object of the present invention to provide an improved process for the recovery and production of lead constituent from a lead bearing paste obtained, from exhausted lead-acid batteries as well as other scrapped lead containing industrial products.

It is another object of the present invention to provide an improved process for producing pure lead oxides from pastes obtained from exhausted lead-acid batteries, without producing hazardous materials and polluting gases.

It is still another object of the present invention to provide an economical process for obtaining pure lead oxides from pastes extracted from exhausted lead-acid batteries.

Other objects and advantages of the present invention will become more apparent when it is described with the aid of the technical details and preferred embodiments as hereinafter mentioned.

### SUMMARY OF INVENTION

According to the present invention, a process for producing fine particles of pure lead oxides from a waste lead oxide paste obtained from exhausted lead-acid batteries characterizes in that said lead oxide particles are substantially spherical and have a weight average particle size from about 13 nm to about 100 nm.

The present invention further proposes a process for producing fine particles of pure lead oxide from waste lead oxide paste as starting material characterizes by the following steps by firstly reacting said starting material with a sodium-based solution to convert the lead compounds therein to insoluble lead carbonate; secondly by dissolving said insoluble lead carbonate by reacting with an acid-based solution to form lead-based solution; thirdly recovering lead oxide powder from said lead-based solution by process of crystallization; fourthly by reacting said lead oxide powder with chlorine and rinsing the resultant lead bearing compound with water; and finally by heating said resultant lead bearing compound to form nano lead oxide particles.

### SPECIFIC EXAMPLE

The invention will now be described by way of example and with reference to the accompanying figures in which:

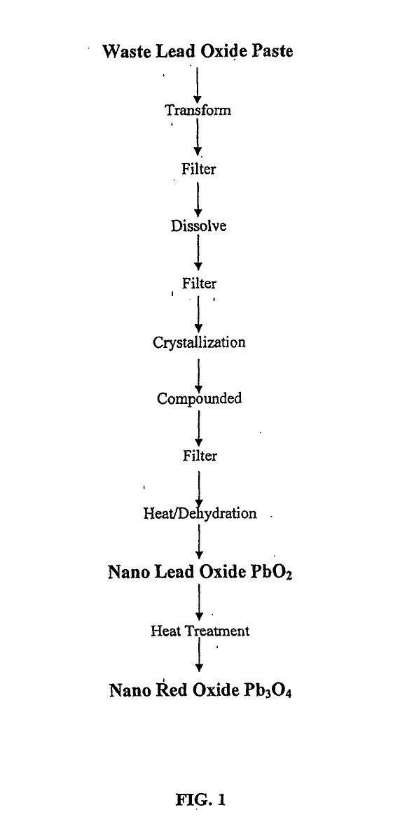

FIG. 1 shows a flow diagram of the continuous process of the present invention for producing fine particles of lead oxides from a waste lead oxide paste obtained from exhausted lead-acid batteries.

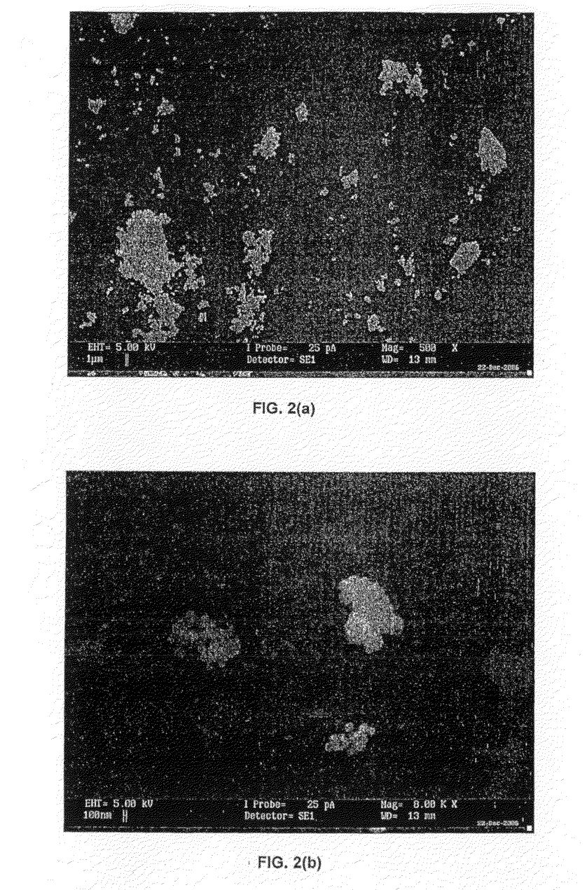

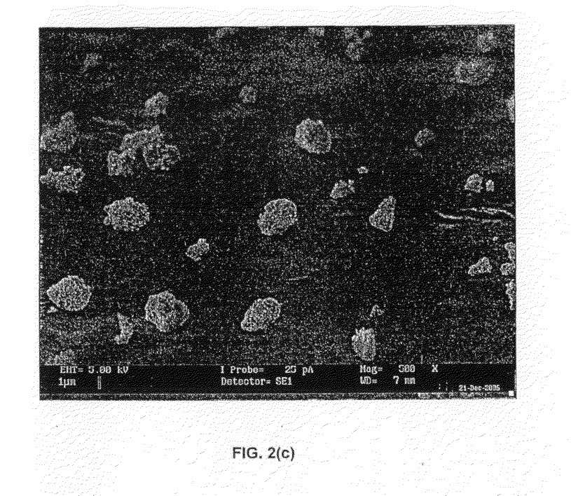

FIG. 2(a) shows a picture of the lead oxide particles produced by the present invention examined under electron microscopy of SEM image 500×

FIG. 2(b) shows a picture of the lead oxide particles produced by the present invention examined under electron microscopy of SEM image 8000×

FIG. 2(c) shows a picture of the lead oxide particles of the present invention being well separated when observed under electron microscopy of SEM image 500×

In a typical process to recover lead from exhausted lead-acid batteries, the batteries are crushed whereby the lead bearing portion is separated from the non-lead bearing portion such as the plastic materials. Generally, the lead bearing portion comprises those chemically still reactive lead components containing lead sulfate, traces of lead dioxide, lead-based alloys and other complex lead compounds. Said lead bearing portion is grinded together with the addition of water to form lead oxide slurry generally referred to as spent or waste battery paste containing lead oxides.

Referring to FIG. 1, the starting material for the present invention is the above-mentioned waste lead oxide paste in slurry form produced out of exhausted lead-acid batteries. According to the present invention, said waste lead oxide paste is delivered to a designated mixer apparatus wherein the paste slurry is mixed with a strong sodium-based alkaline solution e.g. NaOH solution via an initial transformation step in the lead recovery process.

The chemical reaction between the mixture compounds within the mixer apparatus takes place under normal ambient temperature. Advantageously, the mixture compounds are set in stirred condition through some kind of stirring or vibration action so as to achieve higher efficiency in terms of chemical reaction.

The sodium-based solution combines with the lead compounds therein to result in an aqueous solution and a precipitate which is rapidly settling down to the bottom of the mixer apparatus. The complete reaction time would range from about 30 minutes to an hour depending on the compositions of the starting material i.e. the waste lead oxide paste, and concentration of the sodium-based alkaline solution used for the transformation reaction.

It must be appreciated that the complete reaction time can be adjusted according to compositions of the starting material and concentration of the sodium-based alkaline solution used for treatment of said particular starting material. In practice, as it may be difficult to control the compositions of the starting material due to its varied sources of scrapped batteries, it is more likely that the type of sodium-based solution to be used for the reaction and its concentration thereof be controlled.

The aqueous solution is essentially sodium sulfate solution. The precipitate is caused by insoluble materials which include the insoluble lead compounds like lead carbonate precipitate.

According to FIG. 1, the present invention involves a filtration step wherein the aqueous solution resulted out of the above-mentioned chemical reaction is filtered and drained off through a suitable mesh filter. The insoluble residues are collected during said filtration step. On the other hand, the filtrate solution still having reasonable concentration of alkaline composition may be collected or recycled for treating future slurry of waste battery pastes.

The insoluble residues collected by the filtration step, which include lead carbonate and other insoluble lead compounds are transferred to a second mixer apparatus wherein a suitable acid-based solution is added.

The choice for the acid-based solution includes acetic, fluoboric and sulphamic acids. The acid treatment step may take place under normal ambient temperature. Advantageously, it should be conducted within the temperature range of 30 to 80 degree C.

Assuming that acetic acid is the choice, most of the insoluble residue materials are dissolved therein the second mixer apparatus forming a colloidal solution with powdery suspension and some coarse impurity particles from the original waste battery paste and some residual plastic materials. It would take about 2 to 3 hours for the acid-based solution to fully react with said insoluble residue materials conducted under controlled temperature within the range of 30 to 80 degree C.

As mentioned above, the above chemical reaction within the second mixer apparatus should produce a colloidal solution with fine particle suspension and some coarse insoluble particles. The coarse insoluble particles are generally the impurities arising from remnants of plastic materials of the original starting material of waste battery paste. These impurities particles are easily filtered off and rejected from the rest of the lot.

The present invention further involves a filtration step whereby the colloidal solution is filtered by a suitable filtering means. The liquid portion or the filtrate is drained off whilst the fine particles which are present as suspension in the original solution are collected in powder form. Essentially, these powder particles are lead bearing compound.

The above lead bearing compound present in powder form is separated thereof and subject to undergo a process of crystallization within the temperature range of 30 to 80 degree C.

Said lead bearing compound is then delivered to a designated apparatus wherein it shall be compounded or treated with a chlorine-based chemical. Said treatment with chlorine-based chemical will last for less than 10 hours within the temperature range of 45 to 75 degree C.

Throughout the above treatment process, the lead bearing compound present in powder form and the chlorine-based chemical are subject to continuous stirring action to ensure effective chemical reaction between them. The resultant lead bearing substance or compound is then filtered again and retained, which contains essentially pure lead oxides of PbO2 except with some small traces of chlorine.

Therefore, the above resultant lead bearing compound is repeatedly washed with water to remove any residual chlorine that has been trapped on the surfaces thereof. It must be appreciated that the washing process should be as thorough as possible in order that the final product of lead oxide shall be free from any impurities, especially chlorine.

After repeatedly washed with water, the resultant lead bearing compound is subject to a drying process by means of heat treatment in an enclosed environment e.g. heat chamber or oven under a temperature of less than 150 degree C. for about 10 to 15 hours. Said compound is heated therein and thus dehydrated to form fine particles of lead oxide of PbO2, which has a purity level in the excess of 99.99%.

Examination under electron microscopy (SEM) of the lead oxide particles thus produced by the present invention has found that that the particles are substantially spherical in shape, and have a weight average particle size from about 13 nm to about 100 nm. It is estimated that at least 80 weight percent of said lead oxide particles are not larger than twice said average particle size.

The SEM images of FIG. 2(a), FIG. 2(b) and FIG. 2(c) conducted by Plasma Research Laboratory, Physics Department of University of Malaysia show samples of the lead oxide particles that have been produced by the present invention. With the above-mentioned measurements, said lead oxide particles possess physical characteristics of nano particles.

The present invention also proposes to subject the above-mentioned lead oxide particles to a further heat treatment process. As such, said lead oxide particles are delivered to a second heat chamber or oven which operates at approximately 420 to 520 degree C. Within said second heat chamber, the lead oxide particles undergo further heat treatment process for about 14 to 18 hours to produce particles of lead oxide of Pb3 O4 or generally known as red lead. The purity level of said red lead particles is found to be in the excess of 99.99%.

Examination by electron microscopy (SEM) on said red oxide particles also reveals that the particles are substantially spherical in shape and have a weight average particle size from about 13 nm to about 100 nm. With said measurements, the red lead particles of Pb3O4 thus possess the physical characteristics of nano particles.

As various changes and modification can be achieved without departing from the scope and spirit of the above description of the invention, it should be appreciated that the disclosed description of the invention and the figures thereto are intended to be, illustrative only and not be interpreted in limiting sense. The scope of the present invention therefore, should be directed to the appended claims.

1. A process for producing fine particles of pure lead oxide from a waste lead oxide paste obtained from exhausted lead-acid batteries characterizes in that said lead oxide particles are substantially spherical and have a weight average particle size from about 13 nm to about 100 nm.

2. A process for producing fine particles of pure lead oxide as defined in claim 1 characterizes in that at least 80 weight percent of said particles are not larger than twice said average particle size.

3. A process for producing fine particles of pure lead oxide as defined in claim 1 characterizes in that said lead oxide is PbO2.

4. A process for producing fine particles of pure lead oxide as denied in claim 1 characterizes in that said lead Oxide is Pb3O4.

5. A process for producing fine particles of pure lead oxide from waste lead oxide paste as starting material characterizes by the following steps;
reacting said starting material with a sodium-based solution to convert the lead compounds therein to insoluble lead carbonate;
dissolving said insoluble lead carbonate by reacting with an acid-based solution to form lead-based solution;
recovering lead oxide powder from said lead-based solution by process of crystallization;
reacting said lead oxide powder with chlorine and rinsing the resultant lead bearing compound with water; and
heating said resultant lead bearing powder to form nano lead oxide particles

6. A process for producing fine particles of pure lead oxide as defined by claim 5 characterizes in that said sodium-based solution is sodium hydroxide NaOH.

7. A process for producing fine particles of pure lead oxide as defined by claim 5 characterizes in that said acid-based solution is acetic acid.

8. A process for producing fine particles of pure lead oxide as defined by claim 5 characterizes in that the heating of said lead bearing compound is conducted under temperature of not more than 150 degree C. for about 10 to 15 hours to produce nano particles of PbO2.

9. A process for producing fine particles of pure lead oxide as defined by claim 5 characterizes in that the heating of said lead bearing compound is conducted under temperature range of 420 to 520 degree C. for about 14 to 18 hours to produce nano particles of Pb3O4.
